(19) United States
(12) Patent Application Publication
(10) Pub. No.: US 2016/0353417 A1
(43) Pub. Date: Dec. 1, 2016

(54) METHOD FOR TRANSMITTING AND RECEIVING DATA IN WIRELESS LAN SYSTEM SUPPORTING DOWNLINK FRAME TRANSMISSION INTERVAL AND DEVICE FOR SAME

(71) Applicant: LG ELECTRONICS INC., Seoul (KR)

(72) Inventors: Jeongki KIM, Seoul (KR); Kiseon RYU, Seoul (KR); Giwon PARK, Seoul (KR); Suhwook KIM, Seoul (KR); Hangyu CHO, Seoul (KR)

(73) Assignee: LG ELECTRONICS INC., Seoul (KR)

(21) Appl. No.: 15/117,424

(22) PCT Filed: Feb. 10, 2015
(86) PCT No.: PCT/KR2015/001324

§ 371 Date: Aug. 8, 2016

Related U.S. Application Data
(60) Provisional application No. 61/938,637, filed on Feb. 11, 2014.

(51) Int. Cl. H04W 72/04; H04W 72/10

(52) U.S. Cl. CPC H04W 72/042; H04W 72/0446; H04W 72/10; H04W 84/12

(57) ABSTRACT

The present document relates to a wireless communication system and, more particularly, to a data transmission and reception operation between an AP and an STA in a high density wireless LAN system. To this end, the STA receives a beacon frame including downlink frame transmission interval information from the AP, and receives data from the AP through a time interval corresponding to the downlink frame transmission interval information, wherein the data reception from the AP through the time interval corresponding to the downlink frame transmission interval information is processed at a higher priority than the data transmission toward the AP.

### TECHNICAL FIELD

The present invention relates to a wireless communication system, and more particularly, to a method for transmitting and receiving data in a wireless LAN system supporting a downlink frame transmission period and a device for the same.

### BACKGROUND ART

While downlink frame transmission period as proposed hereinbelow may be used in various kinds of wireless communications, a WLAN system will be taken as an exemplary system to which the present invention is applicable.

Standards for the WLAN technology have been developed as Institute of Electrical and Electronics Engineers (IEEE) 802.11 standards. IEEE 802.11a and b use an unlicensed band at 2.4 GHz or 5 GHz. IEEE 802.11b provides a transmission rate of 11 Mbps and IEEE 802.11a provides a transmission rate of 54 Mbps. IEEE 802.11g provides a transmission rate of 54 Mbps by applying Orthogonal Frequency Division Multiplexing (OFDM) at 2.4 GHz. IEEE 802.11n provides a transmission rate of 300 Mbps for four spatial streams by applying Multiple Input Multiple Output (MIMO)-OFDM. IEEE 802.11n supports a channel bandwidth of up to 40 MHz and, in this case, provides a transmission rate of 600 Mbps.

The above-described WLAN standards have evolved into IEEE 802.11ac that uses a bandwidth of up to 160 MHz and supports a transmission rate of up to 1 Gbits/s for 8 spatial streams and IEEE 802.11ax standards are under discussion.

In IEEE 802.11, communication is conducted on a shared wireless medium. Therefore, the communication environment of IEEE 802.11 is fundamentally different from a wired channel environment. For example, communication can be conducted based on Carrier Sense Multiple Access/Collision Detection (CSMA/CD) in the wired channel environment. In other words, once a transmitter transmits a signal, the signal arrives at a receiver without much signal attenuation because there is no great change in the channel environment. If two or more signals collide with each other, they can be detected because power sensed at the receiver instantaneously gets larger than power transmitted by the transmitter.

However, since a channel is affected by various factors (e.g., signal attenuation may increase with a distance or the signal may suffer from instantaneous deep fading) in the wireless channel environment, the transmitter cannot determine by carrier sensing whether the receiver has received a signal successfully or signal collision has occurred.

### DISCLOSURE

### Technical Problem

In the above-described wireless communication system, there is a need for transmitting and receiving a signal by efficiently controlling interference between Stations (STAs). However, since data transmission from an Access Point (AP) may be delayed due to indirect control between STAs in a high density Wireless Local Area Network (WLAN) system, a technique for efficiently performing data transmission from an AP to an STA is required.

### Technical Solution

In one aspect of the present invention to solve the above technical problem, a method for receiving data from an access point (AP) by a station (STA) in a wireless LAN system comprises: receiving a beacon frame including downlink frame transmission window information from the AP; and receiving the data from the AP through a duration corresponding to the downlink frame transmission window information, wherein the data reception from the AP through the duration corresponding to the downlink frame transmission window information is processed at a higher priority than data transmission to the AP.

In another aspect of the present invention, a method for transmitting data to a station (STA) by a access point (AP) in a wireless LAN system comprises: transmitting a beacon frame including downlink frame transmission window information to the STA; and transmitting the data to the STA through a duration corresponding to the downlink frame transmission window information, wherein the data transmission of the AP through the duration corresponding to the downlink transmission window information is processed at a higher priority than data transmission from the STA to the AP.

In still another aspect of the present invention, a station (STA) for receiving data from an access point (AP) in a wireless LAN system comprises a transceiver configured to transmit and receive a radio signal to and from the AP; and a processor configured to be connected with the transceiver to control the operation of the transceiver, wherein the processor is configured to control the transceiver to receive the data from the AP through a duration corresponding to downlink frame transmission window information when the transceiver receives a beacon frame including the downlink frame transmission window information from the AP, and the data reception from the AP through the duration corresponding to the downlink frame transmission window information is processed at a higher priority than data transmission to the AP.

In further still another aspect of the present invention, an access point (AP) for transmitting data to a station (STA) in a wireless LAN system comprises a transceiver configured to transmit and receive a radio signal to and from the STA; and a processor configured to be connected with the transceiver to control the operation of the transceiver, wherein the processor is configured to control the transceiver to transmit a beacon frame including downlink frame transmission window information to the STA and transmit the data to the STA through a duration corresponding to the downlink frame transmission window information, and the data transmission of the AP through the duration corresponding to the downlink frame transmission window downlink frame transmission window information is processed at a higher priority than data transmission from the STA to the AP.

### Advantageous Effects

According to the present invention as described above, system performance can be increased and the data transmission delay of an STA can be minimized, by reducing the data transmission delay of an AP in a high-density WLAN situation in which a plurality of STAs are associated with a single AP.

### BRIEF DESCRIPTION OF THE DRAWINGS

FIG. 1 is a diagram illustrating an exemplary configuration of a Wireless Local Area Network (WLAN) system.

FIG. 2 is a diagram illustrating another exemplary configuration of a WLAN system.

FIG. 3 is a diagram illustrating a Distributed Coordinated Function (DCF) mechanism in a WLAN system.

FIGS. 4 and 5 are exemplary diagrams describing problems encountered with a conventional collision resolution mechanism.

FIG. 6 is a diagram illustrating a mechanism of solving a hidden node issue using a Ready To Send (RTS)/Clear To Send (CTS) frame.

FIG. 7 is a diagram illustrating a mechanism of solving an exposed node issue using an RTS/CTS frame.

FIG. 8 is a diagram illustrating a specific operation method using an RTS/CTS frame.

FIG. 9 is a diagram describing the concept of a downlink oriented channel in a WLAN system.

FIG. 10 is a diagram describing the concept of a downlink frame transmission window according to one aspect of the present invention.

FIG. 11 is a diagram illustrating a method for using a downlink frame transmission window in accordance with another embodiment of the present invention.

FIGS. 12 and 13 are diagrams describing a format a DTW setup information element according to one embodiment of the present invention.

FIG. 14 is a diagram describing that AID is used as STA information which will receive data for a DTW.

FIG. 15 is a diagram describing that GID is used as STA information which will receive data for a DTW.

FIG. 16 is a diagram describing an operation based on immediate response, and FIG. 17 is a diagram describing an operation based on deferred response.

FIG. 18 is a diagram describing a method for transmitting data for a DTW by using TIM based STA information in accordance with one embodiment of the present invention.

FIG. 19 is a diagram describing a method for identifying an STA which will receive data for a DTW through STA information paged from TIM element like FIG. 18.

FIG. 20 is a diagram describing a method for receiving data in a sleep mode STA from an AP for a DTW in accordance with one embodiment of the present invention.

FIG. 21 is a diagram describing that TID is used as STA information which will receive data for a DTW.

FIG. 22 is a diagram describing that AC is used as STA information which will receive data for a DTW.

FIGS. 23 and 24 are DTW information element formats according to the preferred embodiment of the present invention.

FIG. 25 is a block diagram illustrating apparatuses for implementing WLAN operation methods that use a downlink frame transmission window.

### BEST MODE FOR CARRYING OUT THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention.

As described above, a detailed description will be given of the introduction of the concept of a downlink frame transmission window, and a method and apparatus for conducting communication using a downlink oriented channel in a high-density Wireless Local Area Network (WLAN) system.

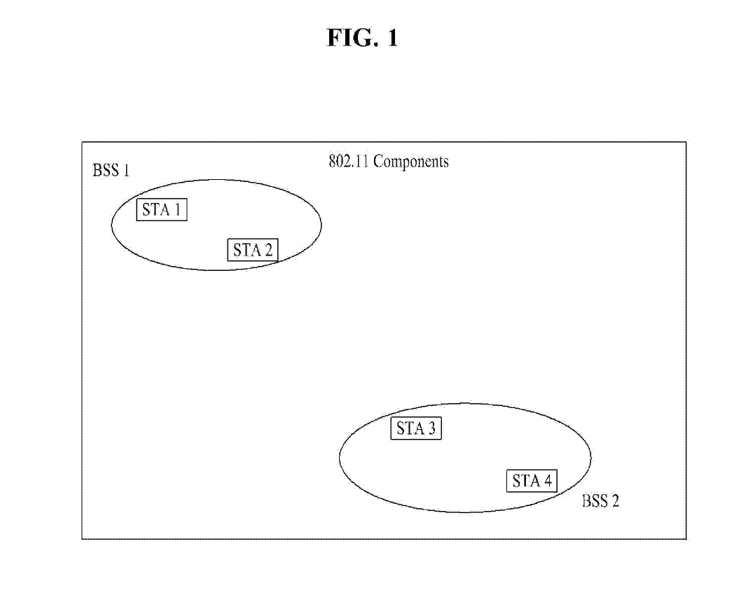

FIG. 1 is a diagram illustrating an exemplary configuration of a WLAN system.

As illustrated in FIG. 1, the WLAN system includes at least one Basic Service Set (BSS). The BSS is a set of STAs that are able to communicate with each other by successfully performing synchronization.

An STA is a logical entity including a physical layer interface between a Medium Access Control (MAC) layer and a wireless medium. The STA may include an AP and a non-AP STA. Among STAs, a portable terminal manipulated by a user is the non-AP STA. If a terminal is simply called an STA, the STA refers to the non-AP STA. The non-AP STA may also be referred to as a terminal, a Wireless Transmit/Receive Unit (WTRU), a User Equipment (UE), a Mobile Station (MS), a mobile terminal, or a mobile subscriber unit.

The AP is an entity that provides access to a Distribution System (DS) to an associated STA through a wireless medium. The AP may also be referred to as a centralized controller, a Base Station (BS), a Node-B, a Base Transceiver System (BTS), or a site controller.

The BSS may be divided into an infrastructure BSS and an Independent BSS (IBSS).

The BSS illustrated in FIG. 1 is the IBSS. The IBSS refers to a BSS that does not include an AP. Since the IBSS does not include the AP, the IBSS is not allowed to access to the DS and thus forms a self-contained network.

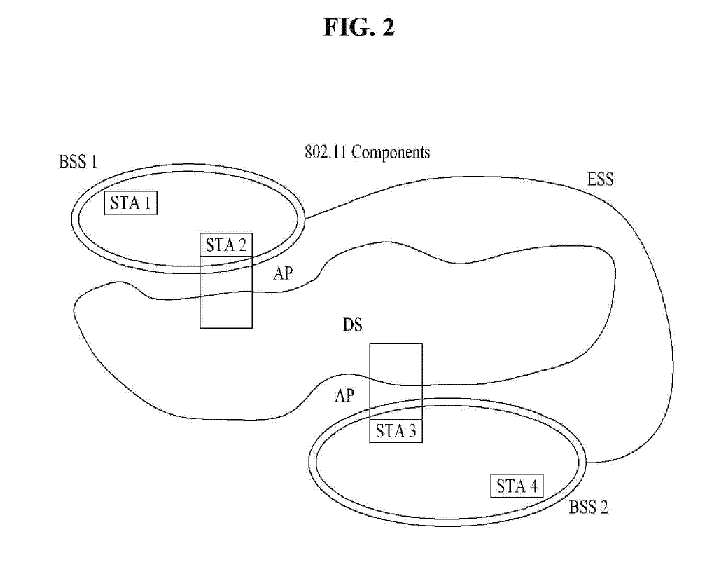

FIG. 2 is a diagram illustrating another exemplary configuration of a WLAN system.

BSSs illustrated in FIG. 2 are infrastructure BSSs. Each infrastructure BSS includes one or more STAs and one or more APs. In the infrastructure BSS, communication between non-AP STAs is basically conducted via an AP. However, if a direct link is established between the non-AP STAs, direct communication between the non-AP STAs may be performed.

As illustrated in FIG. 2, the multiple infrastructure BSSs may be interconnected via a DS. The BSSs interconnected via the DS are called an Extended Service Set (ESS). STAs included in the ESS may communicate with each other and a non-AP STA within the same ESS may move from one BSS to another BSS while seamlessly performing communication.

The DS is a mechanism that connects a plurality of APs to one another. The DS is not necessarily a network. As long as it provides a distribution service, the DS is not limited to any specific form. For example, the DS may be a wireless network such as a mesh network or may be a physical structure that connects APs to one another.

Now, a collision detection scheme in a WLAN system will be described based on the above description.

Because various factors affect a channel in a wireless environment as described before, a transmitter is not capable of detecting a collision accurately. Accordingly, IEEE 802.11 has introduced a Distributed Coordination Function (DCF) being a Carrier Sense Multiple Access/Collision Avoidance (CSMA/CA) mechanism.

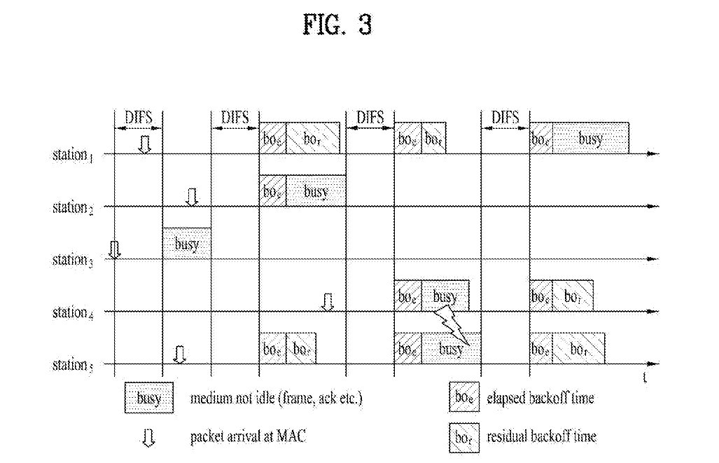

FIG. 3 illustrates a DCF mechanism in a WLAN system.

According to the DCF mechanism, STAs having transmission data perform Clear Channel Assessment (CCA) by sensing a medium during a specific duration (e.g., DCF Inter-Frame Space (DIFS)) before they transmit the data. If the medium is idle, an STA may transmit its data on the medium. On the contrary, if the medium is busy, the STA may transmit its data after further waiting a random backoff period, on the assumption that a plurality of STAs are waiting to use the medium. The random backoff period enables collision avoidance because each STA has a different backoff interval in probability and thus a different transmission time on the assumption that a plurality of STAs are to transmit data. Once one STA starts transmission, the other STAs may not use the medium.

A random backoff time and a random backoff procedure will be described in brief.

If a specific medium transitions from a busy state to an idle state, a plurality of STAs start to prepare for data transmission. To minimize collision, each STA selects a random backoff count and waits for as long a slot time period as the selected backoff count. The random backoff count is a pseudo-random integer and selected from a range of uniformly distributed values, 0 to CW. CW represents ‘contention window’.

Although the CW parameter is initially set to CWmin, it is doubled upon transmission failure. For example, in the case where an ACK for a transmitted frame is not received, it may be determined that collision has occurred. If the CW value reaches CWmax, the STA maintains CWmax until the data transmission is successful. If the data transmission is successful, the CW value is reset to CWmin. Preferably, CW, CWmin, and CWmax are maintained to be 2ⁿ−1, for the convenience of configuration and operation.

When the random backoff procedure starts, the STA selects a random backoff count from the range of the values 0 to CW and continuously monitors the medium while counting down backoff slots according to the random backoff count. If the medium gest busy, the STA discontinues the count-down. When the medium becomes idle, the STA resumes the count-down of the remaining backoff slots.

Referring to FIG. 3, in the case where a plurality of STAs have data to be transmitted, STA3 may immediately transmit a data frame because the medium is idle during a DIFS, whereas the other STAs wait until the medium is idle. Since the medium has been busy for some time, a plurality of STAs may wait for an opportunity to use the medium. Therefore, each STA selects a random backoff count. Herein, STA2 selects a smallest backoff count and thus transmits a data frame in FIG. 3.

After STA2 completes the transmission, the medium gets idle. Then the STAs resume the count-down of the remaining backoff intervals. In FIG. 3, STA5, which has a second-smallest random backoff count and discontinued its count-down while the medium is busy, counts down the residual backoff slots and starts to transmit a data frame. However, the residual backoff time of STA5 happens to be equal to that of STA4. As a result, collision occurs between STA4 and STA5. Since, either STA4 or STA5 does not receive an ACK after the data transmission, STA4 and STA5 double CW values and select random backoff counts again.

As described before, the basics of CSMA/CA is carrier sensing. An STA uses physical carrier sensing and virtual carrier sensing to determine whether a DCF medium is busy or idle. A Physical layer (PHY) performs physical carrier sensing by energy detection or preamble detection. For example, if the PHY determines that a receiver has measured a voltage level or has read a preamble, it may determine that the medium is busy. In virtual carrier sensing, data transmission of other STAs is prevented by setting a Network Allocation Vector (NAV). This is done by means of a value of a Duration field in a MAC header. Meanwhile, a robust collision detection mechanism has been introduced to reduce the probability of collision. The reason for introducing the robust collision detection mechanism will be described with reference to the following two examples. For the convenience of description, it is assumed that a carrier sensing range is identical to a transmission range.

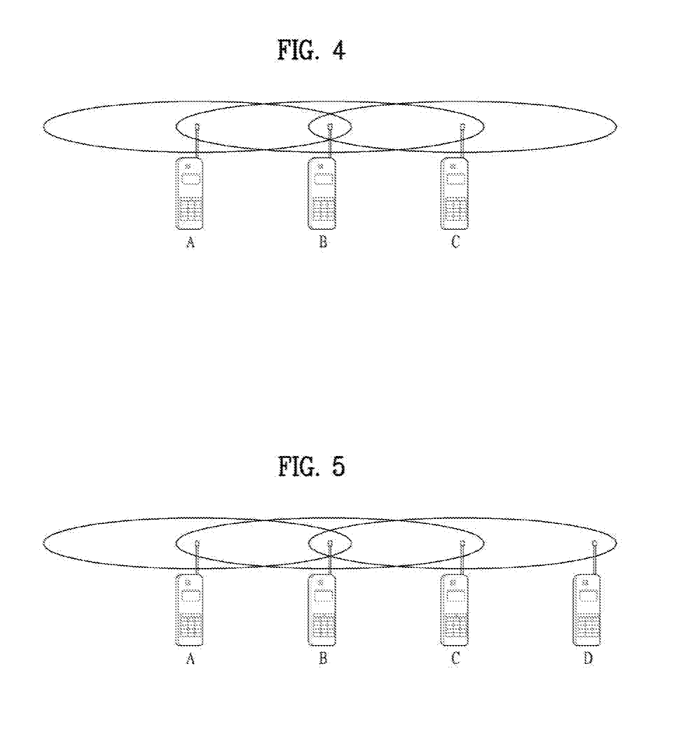

FIGS. 4 and 5 are exemplary diagrams describing problems encountered with a conventional collision resolution mechanism.

Specifically, FIG. 4 is a diagram describing a hidden node issue. In FIG. 4, STA A is communicating with STA B, and STA C has information to be transmitted. Specifically, STA C is likely to determine that a medium is idle during carrier sensing before transmitting data to STA B, although STA A is transmitting information to STA B. Collision occurs because STA B receives information from STA A and STA C simultaneously. Herein, it may be said that STA A is a hidden node to STA C.

FIG. 5 is a diagram describing an exposed node issue. In FIG. 5, STA B is transmitting data to STA A. STA C performs carrier sensing and determines that a medium is busy due to transmission of STA B. Therefore, although STA C has information to be transmitted to STA D, STA C should wait unnecessarily until the medium is idle since the medium is sensed as busy. That is, even though STA A is actually located out of the transmission range of STA C, STA C does not transmit information. Herein, STA C is an exposed node to STA B.

To efficiently utilize a collision avoidance mechanism in the above situation, short signaling packets such as Request To Send (RTS) and Clear To Send (CTS) frames may be introduced, so that neighboring STAs may determine by overhearing whether information is transmitted between two STAs. That is, if a transmitting STA transmits an RTS frame to a receiving STA, the receiving STA may indicate to its neighboring STAs that it will receive data by transmitting a CTS frame to the neighboring STAs.

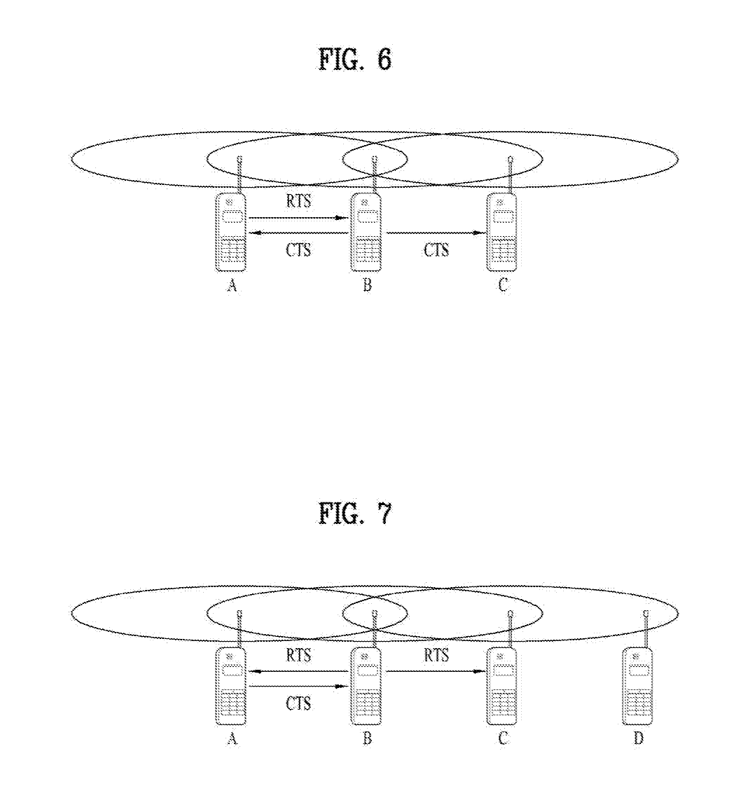

FIG. 6 illustrates a mechanism of solving the hidden node issue.

In FIG. 6, both STA A and STA C are to transmit data to STA B. If STA A transmits an RTS frame to STA B, STA B transmits a CTS frame to its neighboring STAs, both STA A and STA C. As a consequence, STA C waits until STA A and STA B complete data transmission, thus avoiding collision.

FIG. 7 illustrates a mechanism of solving the exposed node issue using an RTS/CTS frame.

It is noted from FIG. 7 that since STA C overhears RTSC/CTS transmission between STA A and STA B, transmission of STA C to STA D does not cause collision. That is, STA B transmits an RTS frame to all neighboring STAs, and only STA A having actual transmission data transmits a CTS frame. Since STA C receives only the RTS frame without receiving the CTS frame, STA C may be aware that STA A is outside the CS range of STA C.

FIG. 8 is a diagram illustrating a method for operating using the above-described RTS/CTS frame.

In FIG. 8, a transmitting STA may transmit an RTS frame to a receiving STA after a DIFS. Upon receipt of the RTS frame, the receiving STA may transmit a CTS frame to the transmitting STA after a Short IFS (SIFS). Upon receipt of the CTS frame from the receiving STA, the transmitting STA may transmit data after an SIFS, as illustrated in FIG. 8. Upon receipt of the data, the receiving STA may transmit an ACKnowledgement (ACK) in response to the received data.

Meanwhile, an STA, which has received the RTS/CTS frame of the transmitting STA among neighbor STAs, may determine whether a medium is busy according to reception or non-reception of the RTS/CTS frame, as described before with reference to FIGS. 6 and 7, and may set a Network Allocation Vector (NAV) accordingly. Upon expiration of a time period indicated by the NAC, the collision resolution operation described with reference to FIG. 3 may be performed after a DIFS.

In the legacy WLAN system, a frame is transmitted in a contention-based manner according to a predetermined criterion (e.g., DCF, Enhanced Distributed Channel Access (EDCA), and the like) irrespective of an AP or a non-AP STA. For example, in a state where 100 non-AP STAs are associated with a single AP, every STA transmits a frame equally by contention irrespective of an AP or a non-AP STA. In an actual WLAN environment, the amount of data that an AP transmits to all STAs is larger than or approximate to the amount of data that every STA transmits to the AP. Accordingly, if the AP has data to be transmitted to a number of STAs and many STAs have transmission data, contention may be heated or many collisions may occur. As a consequence, as the AP transmits data to the last STA with a time delay, a user's Quality of Service (QoS) may not be satisfied, or a packet transmission timeout may occur, thus causing discarding of a packet. This situation may be fatal to real-time service such as audio/video streaming.

Moreover, a large amount of data transmitted by the AP may delay transmissions of STAs and thus increase the number of STAs attempting frame transmission. In this case, UL transmissions are suddenly concentrated after a DL transmission, resulting in lots of collisions from hidden nodes as described before.

To reduce collision between the DL and the UL in such a high density wireless LAN environment, a downlink channel may be managed separately from a general wireless LAN channel.

FIG. 9 is a diagram describing the concept of a downlink oriented channel in a WLAN system.

As shown in FIG. 9, when the AP may use one or more channels, the one or more channels may be set as downlink oriented channels for transmitting data from the AP to STAs connected to the AP. In FIG. 9, CH1 indicates a downlink oriented channel and CH2 indicates a general channel.

The AP should have a general channel that may support association of the STA or legacy STAs. That is, in FIG. 9, it is assumed that association of the STA through CH2 and data transmission and reception in the legacy wireless LAN system are performed equally.

Meanwhile, in the downlink oriented channel CH1 introduced in accordance with this method, the AP may perform data transmission to the STAs connected therewith without contention with uplink data transmission as described above, and may receive uplink data through the general channel CH2. In this case, although the downlink oriented channel may be different from the general channel in that uplink data transmission is not performed, a control signal (e.g., ACK/NACK) of the STA associated with data transmission of the AP may be transmitted through this downlink oriented channel.

However, the management of the downlink oriented channel as described above is limited to a case that the AP may use a plurality of channels, and it is required that one of the plurality of channels should be used by being allocated to the downlink oriented channel. Therefore, in one aspect of the present invention, it is suggested that a downlink (DL) frame transmission period (DL transmission window (DTW)) should be set and managed within a specific channel by expanding the concept of the aforementioned downlink oriented channel to a time domain of the specific channel.

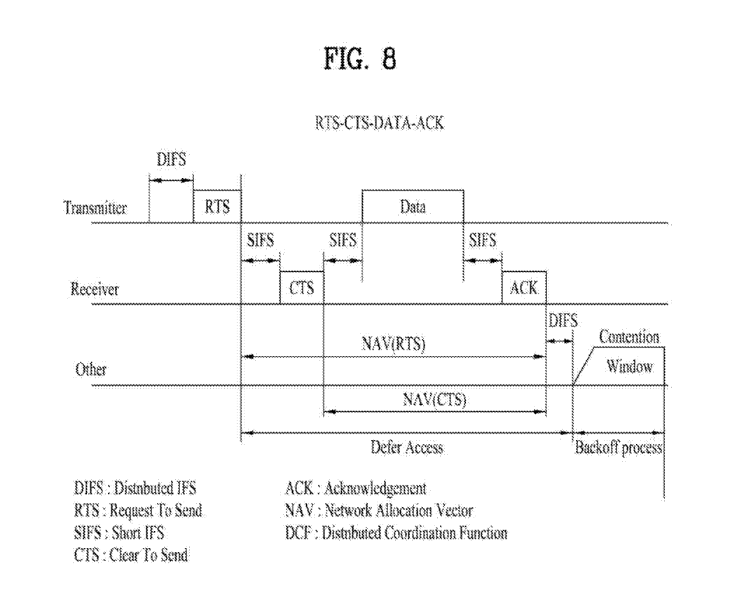

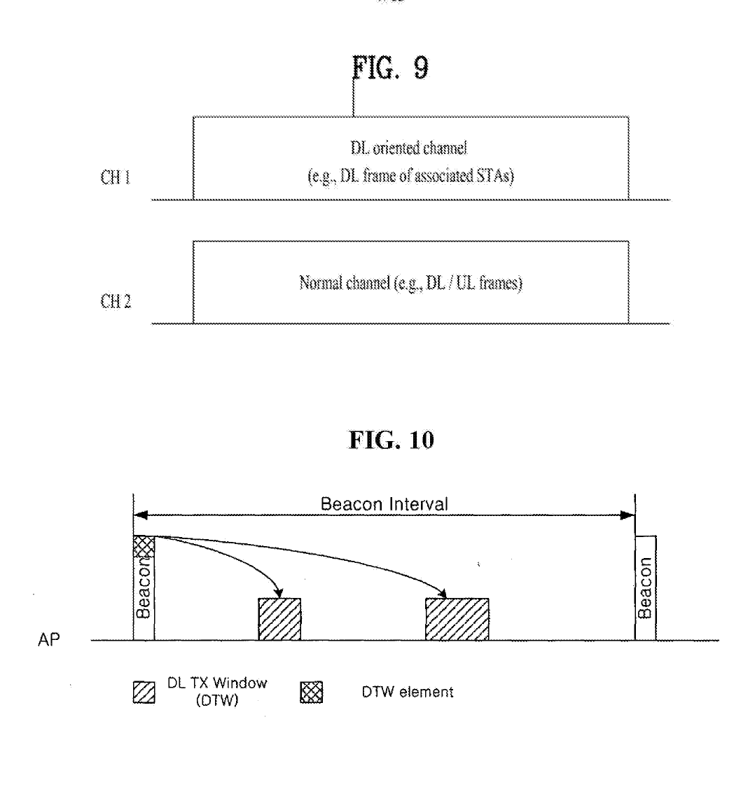

FIG. 10 is a diagram describing the concept of a downlink frame transmission window according to one aspect of the present invention.

In this embodiment, the AP may deliver DL frame transmission window (DTW) information to the STA through a beacon frame (or another broadcast frame). As shown in FIG. 10, the AP may allocate one or more of the DL frame transmission windows within one beacon interval. Also, the AP may periodically allocate the DL frame transmission window within one beacon interval or for several beacon transmission periods.

It is preferable that the STAs which have received a beacon may acquire DL frame transmission window information included in the beacon frame and do not try frame transmission to the AP for the corresponding interval on the basis of the acquired information. Also, it is preferable that the STA which has acquired the DL frame transmission window by receiving the beacon terminates frame transmission prior to the DL frame transmission window.

In the example of FIG. 10, the AP allocates two DTWs within the beacon interval.

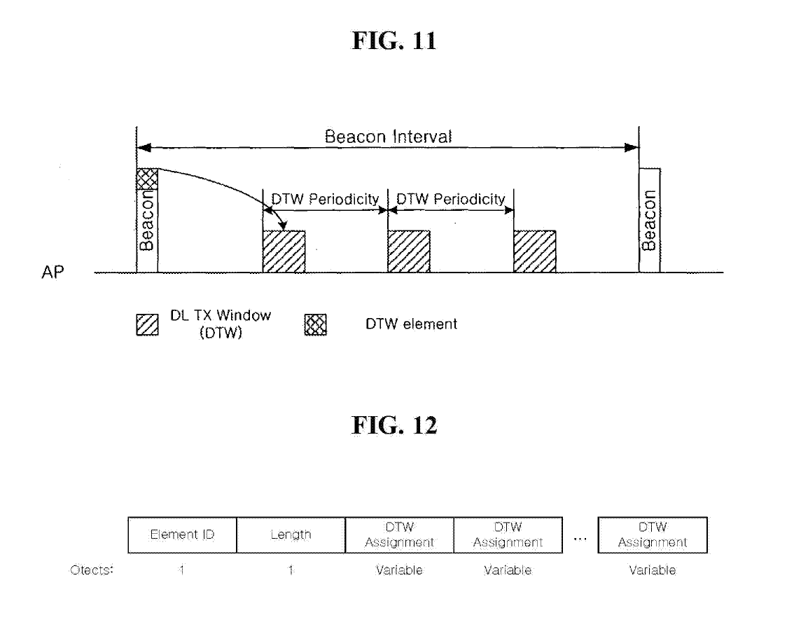

FIG. 11 is a diagram illustrating a method for using a downlink frame transmission window in accordance with another embodiment of the present invention.

In more detail, FIG. 11 illustrates that the AP periodically sets a DTW through the beacon frame. To this end, the beacon frame may include information such as the fact of DTW setup, DTW setup period, and the number of repetition times of DTW within the beacon interval.

Similarly to the concept of the aforementioned downlink oriented channel in respect of FIG. 9, it is preferable that the STA is prohibited to transmit data to the AP even within the downlink frame transmission window described in FIGS. 10 and 11. However, unlike the concept of the downlink oriented channel of FIG. 9, a channel through the downlink frame transmission window of FIGS. 10 and 11 is set is a general wireless LAN channel, and the legacy STA may transmit data to the AP without knowing the presence of the downlink frame transmission window. Also, unlike the STA associated with the corresponding AP, the STAs which belong to another BSS may transmit data to its AP for the DTW by failing to receive DTW setup information of the beacon frame, which is transmitted from the corresponding AP.

Therefore, in the example of FIG. 10 or 11, it is preferable that the AP tries transmission of DL frame for the DTW before the DTW starts or if a channel is idle for PIFS of the DTW. Also, if the AP transmits DL frame based on EDCA for the DTW, the AP is preferably set to try DL frame transmission with a priority higher than that of the other STA. If the AP transmits data based on EDCA, the priority may follow EDCA parameters as illustrated in Table 1 below.

TABLE 1

| | | | | TXOP limit | | |
|---|---|---|---|---|---|---|
| | | | | | For PHYs defined | |
| | | | | | in Clause 18, | |
| | | | | For PHYs defined | Clause 19, | |
| | | | | in Clause 16 and | Clause 20, and | Other |
| AC | CWmin | CWmax | AIFSN | Clause 17 | Clause 22 | PHYs |
| AC_BK | aCWmin | aCWmax | 7 | 0 | 0 | 0 |
| AC_BE | aCWmin | aCWmax | 3 | 0 | 0 | 0 |
| AC_VI | (aCWmin + 1)/2 − 1 | aCWmin | 2 | 6.016 ms | 3.008 ms | 0 |
| AC_VO | (aCWmin + 1)/4 − 1 | (aCWmin + 1)/2 − 1 | 2 | 3.264 ms | 1.504 ms | 0 |

In one embodiment of the present invention, it is suggested that AC_V0 should be used by being allocated to data transmission of the AP for the DTW to give the highest priority of the aforementioned EDCA parameters. Also, in another embodiment of the present invention, EDCA parameter having a priority higher than the EDCA parameters defined Table 1 may be defined for the DTW, whereby the EDCA parameter may be used for data transmission of the AP for the DTW.

Meanwhile, in other embodiment of the preset invention, the AP may exchange RTS/CTS frame with the STA before transmitting DL frame for the DTW. For the DL frame transmission window, when the channel is idle, only the AP may transmit the frame, or the AP may transmit the frame at a priority higher than the other STA.

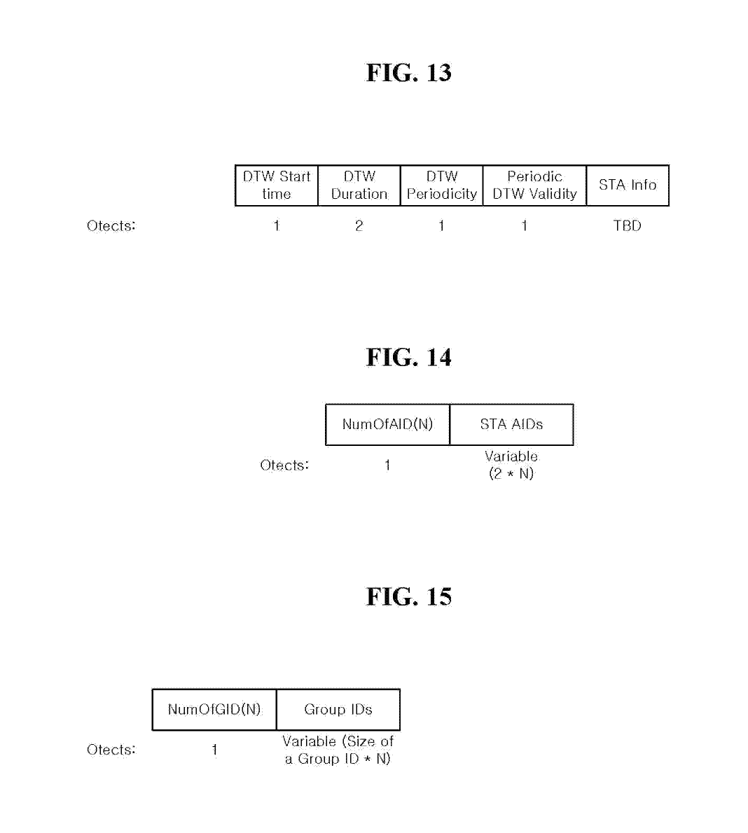

FIGS. 12 and 13 are diagrams describing a format a DTW setup information element according to one embodiment of the present invention.

As shown in FIG. 12, the DTW information element within the beacon frame transmitted from the AP may include an element ID field, a length field, and one or more DTW assignment information elements. That is, one beacon frame may include a plurality of DTW assignment information elements, each of which has a variable length.

Meanwhile, as shown in FIG. 13, each DTW assignment information element may include a DTW start time field, a DTW duration field, a DTW periodicity field, a periodic DTW validity field, and an STA information field.

The DTW start time field has a 1-byte size and may be a TU as a duration from next to a current beacon to a start of the DTW. The DTW duration field may indicate a length of the DTW. Also, the DTW periodicity field may indicate a period of the DTW allocated within one beacon interval. Also, the periodic DTW validity field may periodically provide information as to how many times the DTW is repeated.

The STA information field indicates information of STAs which will receive the frame transmitted through the DTW, and may be expressed using one of various format types defined as follows.

(1) AID Based STA Information

AID (Association Identifier) information of the STA which uses the DTW may be transmitted by being included in the STA information, and the STAs corresponding to AID may receive DL frame from the AP for the DTW.

FIG. 14 is a diagram describing that AID is used as STA information which will receive data for a DTW.

As shown in FIG. 14, the AID information element may include AID number field NumOfAID of 1 octet length and ID information field of STA which will receive data from the AP for the DTW. In the corresponding information element, AID field of the STA may have a variable length in accordance with the number of STAs which will receive data for the DTW as shown in FIG. 14.

(2) GID Based STA Information

Group ID may be included in the STA information element, and the STAs which belong to a group corresponding to the corresponding group ID may use the DTW. That is, all of the STAs within the corresponding group may receive DL frame from the AP for the DTW.

FIG. 15 is a diagram describing that GID is used as STA information which will receive data for a DTW.

As shown in FIG. 15, a GID based station information element may include GID number field NumOfGID of 1 octet length and group ID field which will receive data for the DTW. A plurality of GIDs which will receive data for the DTW may be provided and therefore may have a variable length.

Meanwhile, if the DTW is used for one GID only, the GID number field NumOfTID may not be included in the STA information.

(3) TIM Based STA Information

In the IEEE 802.11 standard, a power saving mechanism is provided to increase a lifespan of a WLAN STA. For power saving, the WLAN STA is operated in two modes of an active mode and a sleep mode. The active mode means the state that a normal operation such as frame transmission and reception or channel scanning is possible. By contrast, since power consumption is reduced extremely in the sleep mode, frame transmission and reception is impossible and channel scanning is also impossible. According to the basic operation principle of the WLAN STA, the WLAN STA is switched from the sleep mode to the active mode if necessary to reduce power consumption.

Since power consumption is reduced if the WLAN STA may be operated for a long time if possible in the sleep mode, lifespan of the WLAN STA is increased. However, since frame transmission and reception is impossible in the sleep mode, the WLAN STA cannot be operated unconditionally for a long time in the sleep mode. If there is a frame to be transmitted in the sleep mode, since the WLAN STA is switched to the active mode to transmit the frame, there is no big problem. However, if the STA is in the sleep mode and the AP has a frame to be transmitted to the STA, the STA cannot receive the frame and cannot know there is a frame to be received by itself. Therefore, the STA should sometimes be switched to the active mode to receive a frame if there is the frame to be received by itself, and should be operated in a reception mode. The AP should notify the STA of the presence of the frame to be transmitted to the STA, at the corresponding time.

The WLAN STA periodically wakes up from the sleep mode to know that there is a frame to be received by itself, and receives the beacon frame from the AP. The AP notifies each STA whether there is a frame to be received by the STA, by using a TIM element of the beacon frame. The TIM element includes two types, TIM and DTIM, wherein the TIM may be used to indicate a unicast frame, and the DTIM may be used to indicate multicast/broadcast frame.

The STA which has known there is a frame to be transmitted thereto through the TIM element of the beacon frame transmits a PS-Poll frame through contention. The AP which has received the PS-Poll frame may be operated by selecting immediate response or deferred response depending on the status.

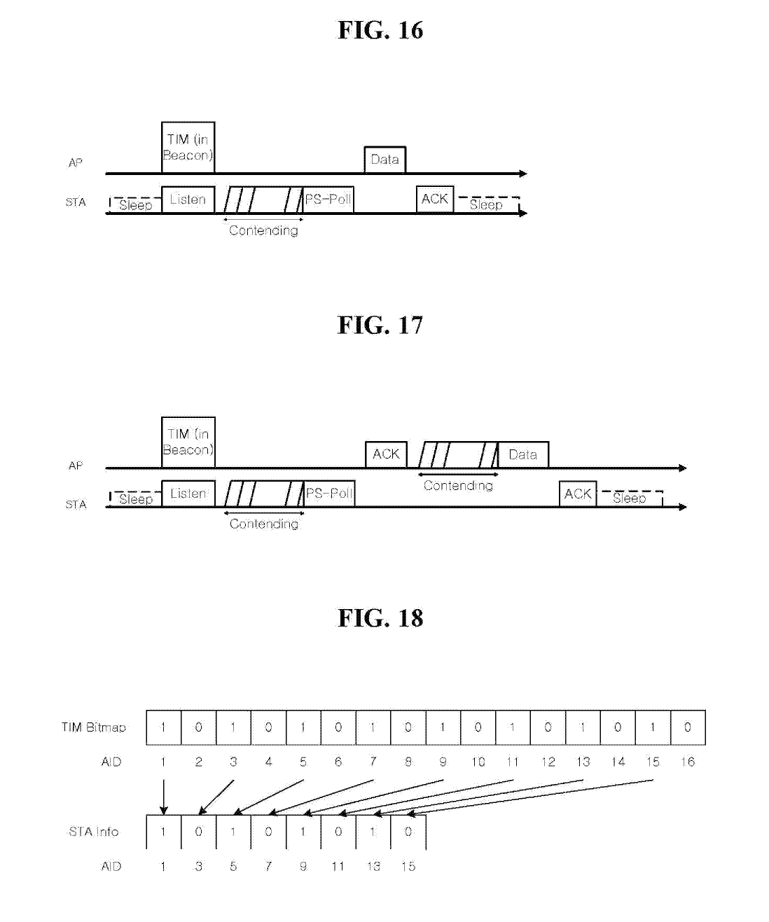

FIG. 16 is a diagram describing an operation based on immediate response, and FIG. 17 is a diagram describing an operation based on deferred response.

As shown in FIG. 16, the STA which has woken up from the sleep mode may receive the beacon frame, which includes the TIM element, from the AP and therefore may recognize that the AP has data to be transmitted to the STA. In this way, the STA which has recognized data to be transmitted from the AP may transmit a PS-poll signal to the AP through contention. In case of immediate response as shown in FIG. 16, the AP which has received the PS-Poll frame from the STA may transmit a data frame to the corresponding STA immediately after next SIFS time. If data are normally received, the STA may transmit ACK frame after SIFS and may again be switched to the sleep mode.

Meanwhile, if the AP fails to prepare for the data frame for SIFS time after receiving the PS-Poll frame, the AP may select deferred response as shown in FIG. 17. As shown in FIG. 17, the AP first transmits ACK frame after receiving the PS-Poll frame from the STA, and then if the AP prepares for the data frame, the AP may transmit the data frame to the STA through contention. The STA which has normally received the data frame may transmit the ACK frame and then may be switched to the sleep mode.

A method for transmitting data for a DTW by using TIM based STA information in accordance with one embodiment of the present invention on the basis of the aforementioned sleep mode operation is as follows.

In this embodiment, the TIM based STA information may be used to indicate information of STAs, which will be received through the DTW, among paged STAs. In this case, a length of the STA information may be determined based on a total number of AID bits set to 1 in the TIM. For example, if the number of AIDs set to 1 in the TIM is 8, the length of the STA information is 8 bits, each of which may indicate STAs corresponding to the AID set to 1. The STA information may be set to transmit a frame to the STAs set to 1 through the DTW and not to transmit a frame to the STAs set to 0 through the corresponding DTW.

FIG. 18 is a diagram describing a method for transmitting data for a DTW by using TIM based STA information in accordance with one embodiment of the present invention.

In the example of FIG. 18, since STAs corresponding to AID 1, 3, 5, 7, 9, 11, 13, 15 have been paged at a TIM bitmap, STA information field may be determined based on the corresponding AID. At this time, since the STAs corresponding to AID 1, 5, 9, 13 are indicated by the STA information, the corresponding STAs may determine that the AP will transmit the frame for the DTW.

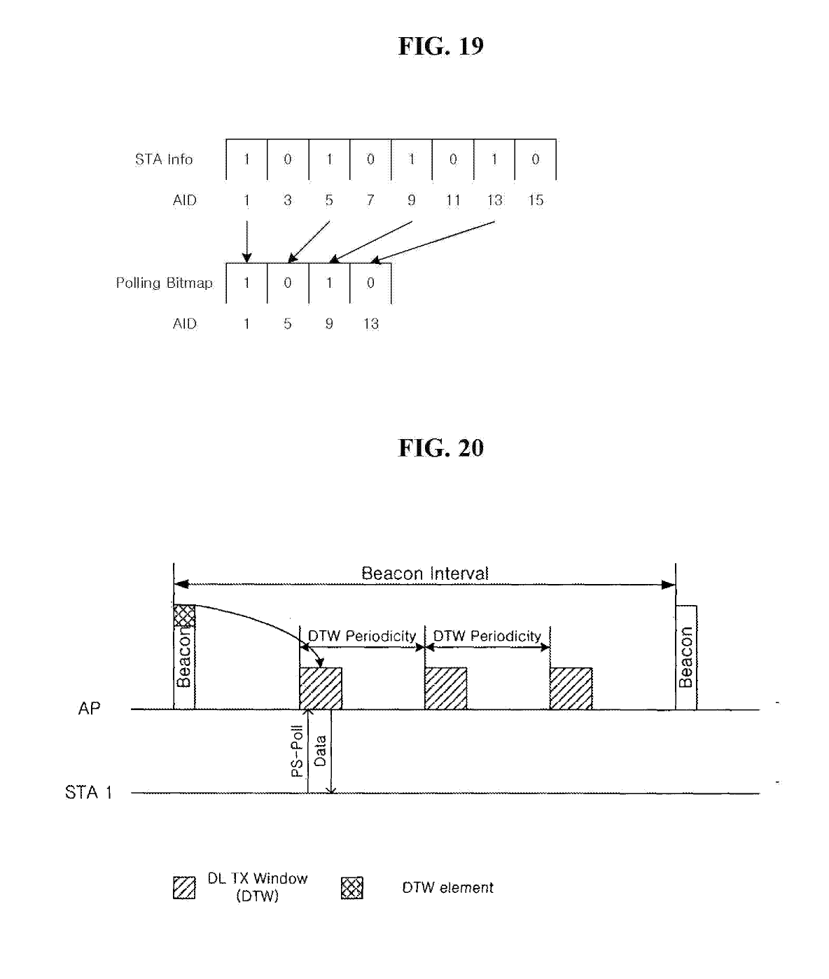

FIG. 19 is a diagram describing a method for identifying an STA which will receive data for a DTW through STA information paged from TIM element like FIG. 18.

At this time, STAs indicated by the STA information may determine whether to transmit PS-Poll by means of information transmitted from the AP after receiving a beacon as shown in FIG. 19. For example, if the AP has another traffic to be transmitted to the STA in addition to traffic which will be transmitted through the DTW, information on the corresponding STA is included in the traffic. In the example of FIG. 19, a method for delivering information, which determines whether to transmit PS-Poll, by using an STA information bitmap is illustrated.

Since the STA information bit map indicates that traffic is transmitted to AID 1, 5, 9, 13 through the DTW and a polling bitmap indicates that the STAs corresponding to AID 1, 9 transmit PS-Poll, the STAs corresponding to AID 1, 9 may try PS-Poll transmission to the AP simultaneously with receiving the frame from the AP through the DTW.

If the polling bitmap is not included, the STAs indicated by the STA information may receive the frame transmitted from the AP for the allocated DTW without trying PS-Poll transmission after receiving the beacon.

In order that the STAs indicated by the STA information comprised based on the TIM bitmap receive the frame from the AP for the first DTW, the STAs may transmit PS-Poll to the AP.

FIG. 20 is a diagram describing a method for receiving data in a sleep mode STA from an AP for a DTW in accordance with one embodiment of the present invention.

In the example of FIG. 20, it is assumed that STA1 is a power saving mode STA and is indicated by TIM. Also, it is assumed that STA is indicated by STA information of DTW element as STA which will receive data from the AP.

Therefore, the STA1 may receive DL frame from the AP after transmitting PS-Poll for the first DTW as shown in FIG. 20. The power saving mode STAs indicated by the STA information may enter a doze state for power saving for the intervals other than the DTW allocated thereto.

(4) TID Based (or AC Based) STA Information

The AP may transmit STA information by including traffic information (traffic ID (TID)), which will be transmitted for the DTW, in the STA information. STAs (that is, STAs (U-APSD and S-APSD) which transmit and receive ADDTS request/response to and from the AP) enabled for the corresponding TID may expect frame reception for the DTW corresponding to the TID.

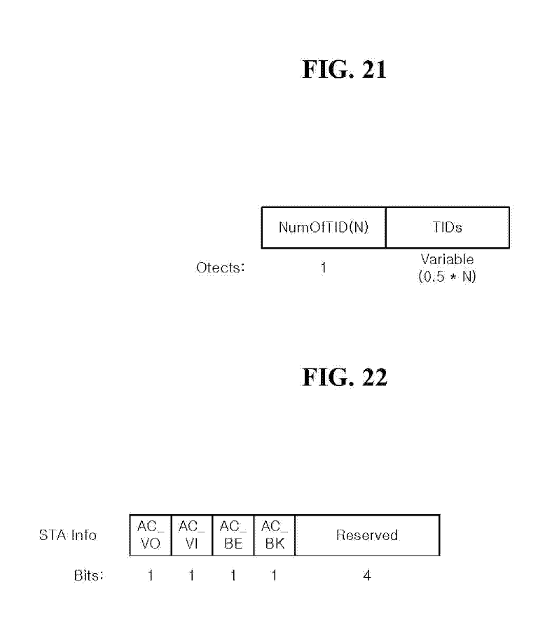

FIG. 21 is a diagram describing that TID is used as STA information which will receive data for a DTW.

A number of TIDs field of 1 octet length may indicate the number of TIDs of STAs which will receive data from the AP for the DTW as shown in FIG. 21. Also, a plurality of TID field may be included in this information element depending on STAs which receive data for the DTW.

In this example, TID is 4 bits, and may be displayed as much as the number of TIDs. If the DTW is allocated to one TID, the number of TIDs field may not be included in STA information.

Meanwhile, instead of TID, access category (for example, AC_VO, AC_VI, AC_BE, AC_BK) may be included in the STA information.

FIG. 22 is a diagram describing that AC is used as STA information which will receive data for a DTW.

As shown in FIG. 22, first 4 bits indicate each AC, and the other bits may be reserved. An STA which is enabled for an access category set to 1 of corresponding bits may receive data from the AP by using a DTW indicated by DTW assignment.

STAs operated by APSD may receive DL frame while performing an operation designated thereto, among two APSD operations (Scheduled-APSD, Unscheduled-APSD). The corresponding STAs may not try UL frame transmission for the DTW.

Meanwhile, the preferred embodiment of the present invention suggests that the AP should selectively use an STA information format defined as above. If the AP selectively uses the STA information format method defined as above, a DTW element may include a field for controlling the STA information format method.

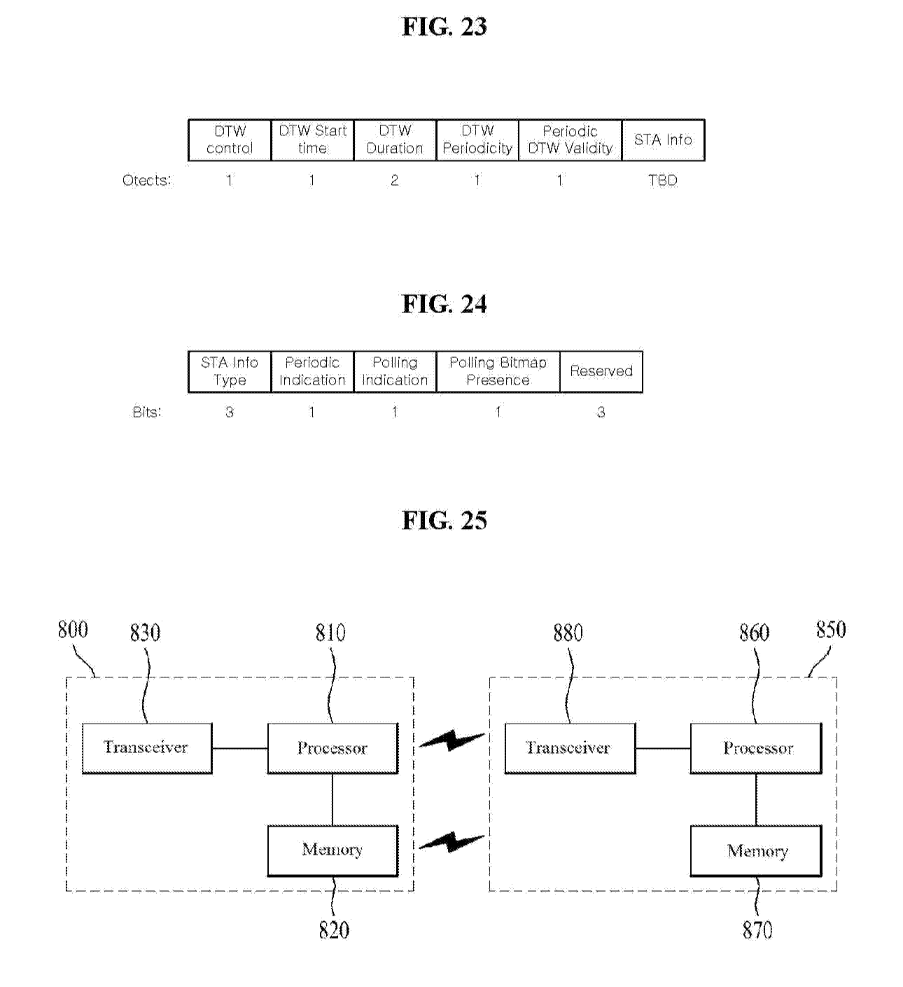

FIGS. 23 and 24 illustrate DTW information element formats according to the preferred embodiment of the present invention.

The DTW information element format illustrated in FIG. 23 may be the same as that of FIG. 12 except that a DTW control field is included in the uppermost of the DTW element. A location of the DTW control field is exemplary, and may be different from the example of FIG. 23.

FIG. 24 is a diagram exemplarily describing a format of a DTW control field added to FIG. 23.

In the example of FIG. 24, an STA information type field indicates one of STA information types defined as described above, and may be defined as follows.

TABLE 2

000: AID based STA Info
001: GID based STA Info
010: TIM based STA Info
011: TID based STA Info
100: AC based STA Info
101~111: reserved

The STAs which receive data from the AP may be diverse depending on the status of BSS. According to this embodiment, it is advantageous that the method of the smallest overhead may be selected to indicate STAs which will receive data.

Meanwhile, a periodic indication field of FIG. 24 indicates whether the DTW is periodically allocated, and indicates that the DTW is periodically allocated if it is set to 1. Also, a DTW period field and a periodic DTW assignment number of times field may be included in the DTW. On the contrary, if the periodic indication field is set to 0, it indicates that the DTW is allocated once, and the DTW period field and the periodic DTW assignment number of times field may not be included in the DTW element.

A polling indication field may determine whether power saving mode STAs indicated by STA information will receive a frame after transmitting PS-Poll for the first DTW. Generally, the polling indication field is valid in case of TIM based STA information, and may be valid even in case of AID/GID based STA information.

A polling bitmap presence field may indicate whether the aforementioned polling bitmap is included in the DTW, and may indicate that the polling bitmap is included in the DTW element when it is set to 1. Generally, the polling bitmap presence field may be valid in AID based STA information or TIM based STA information.

If DL frame transmission is early completed for the DTW, the AP may early end the DTW. At this time, the AP may transmit a frame (for example, CF-END frame) which indicates that the DTW is early ended. The STA which has received the frame indicating that the DTW is early ended may use a channel for data transmission since then.

FIG. 25 is a block diagram illustrating apparatuses for implementing WLAN operation methods that use a downlink frame transmission window.

A wireless apparatus 800 of FIG. 25 may correspond to the above-described STA and a wireless apparatus 850 of FIG. 25 may correspond to the above-described AP.

The STA 800 may include a processor 810, a memory 820, and a transceiver 830 and the AP 850 may include a processor 860, a memory 870, and a transceiver 860. The transceivers 830 and 880 may transmit/receive a wireless signal and may be implemented in a physical layer of IEEE 802.11/3GPP. The processors 810 and 860 are implemented in a physical layer and/or a MAC layer and are connected to the transceivers 830 and 880. The processors 810 and 860 may perform the above-described UL MU scheduling procedure.

The processors 810 and 860 and/or the transceivers 830 and 880 may include an Application-Specific Integrated Circuit (ASIC), a chipset, a logical circuit, and/or a data processor. The memories 820 and 870 may include a Read-Only Memory (ROM), a Random Access Memory (RAM), a flash memory, a memory card, a storage medium, and/or a storage unit. If an embodiment is performed by software, the above-described method may be executed in the form of a module (e.g., a process or a function) performing the above-described function. The module may be stored in the memories 820 and 870 and executed by the processors 810 and 860. The memories 820 and 870 may be located at the interior or exterior of the processors 810 and 860 and may be connected to the processors 810 and 860 via known means.

The detailed description of the preferred embodiments of the present invention has been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

While the present invention has been described above in the context of an IEEE 802.11 WLAN system, the present invention is not limited to the specific system. Therefore, the present invention is applicable in the same manner to various wireless systems requiring control of interference between wireless devices.

1. A method for receiving data from an access point (AP) by a station (STA) in a wireless LAN system, the method comprising:
receiving a beacon frame including downlink frame transmission window information from the AP; and
receiving the data from the AP through a duration corresponding to the downlink frame transmission window information,
wherein the data reception from the AP through the time period corresponding to the downlink frame transmission window information is processed at a higher priority than data transmission to the AP.

2. The method according to claim 1, wherein an enhanced distributed channel access (EDCA) parameter for the highest priority is set for data reception from the AP through the duration corresponding to the downlink frame transmission window information.

3. The method according to claim 1, wherein the downlink frame transmission window information sets a plurality of downlink frame transmission windows within a beacon transmission period of the AP.

4. The method according to claim 3, wherein the plurality of downlink frame transmission windows are arranged at a predetermined period.

5. The method according to claim 1, wherein the downlink frame transmission window information includes start point information of the downlink frame transmission window, duration information of the downlink frame transmission window, period information of the downlink frame transmission window, the number of repetition times information of the downlink frame transmission window, and station information which will transmit data through the downlink frame transmission window.

6. The method according to claim 5, wherein the station information includes one or more of AID (association identifier) based station information, group ID based station information, TIM (traffic indication map) based station information, and AC (accessory category) based station information.

7. The method according to claim 6, wherein, when the station information includes the TIM based station information, the station information includes information indicating a station, which will receive data for the downlink frame transmission window, among stations indicated by a TIM bitmap.

8. The method according to claim 6, wherein, when the station information includes the TIM based station information, the downlink frame transmission window information additionally includes information as to whether a station corresponding to the station information will receive data based on PS polling.

9. A method for transmitting data to a station (STA) by an access point (AP) in a wireless LAN system, the method comprising:
transmitting a beacon frame including downlink frame transmission window information to the STA; and
transmitting the data to the STA through a duration corresponding to the downlink frame transmission window information,
wherein the data transmission of the AP through the duration corresponding to the downlink frame transmission window information is processed at a higher priority than data transmission from the STA to the AP.

10. The method according to claim 9, wherein an enhanced distributed channel access (EDCA) parameter for the highest priority is set for data transmission of the AP through the duration corresponding to the downlink frame transmission window information.

11. The method according to claim 9, wherein the downlink frame transmission window information includes start point information of the downlink frame transmission window, duration information of the downlink frame transmission window, period information of the downlink frame transmission window, the number of repetition times information of the downlink frame transmission window, and station information which will transmit data through the downlink frame transmission window.

12. A station (STA) for receiving data from an access point (AP) in a wireless LAN system, the STA comprising:
a transceiver configured to transmit and receive a radio signal to and from the AP; and
a processor configured to be connected with the transceiver to control the operation of the transceiver,
wherein the processor is configured to control the transceiver to receive the data from the AP through a duration corresponding to downlink frame transmission window information when the transceiver receives a beacon frame including the downlink frame transmission window information from the AP, and the data reception from the AP through the duration corresponding to the downlink frame transmission window information is processed at a higher priority than data transmission to the AP.

13. An access point (AP) for transmitting data to a station (STA) in a wireless LAN system, the AP comprising:
a transceiver configured to transmit and receive a radio signal to and from the STA; and
a processor configured to be connected with the transceiver to control the operation of the transceiver,
wherein the processor is configured to control the transceiver to transmit a beacon frame including downlink frame transmission window information to the STA and transmit the data to the STA through a duration corresponding to the downlink frame transmission window information, and the data transmission of the AP through the duration corresponding to the downlink frame transmission window information is processed at a higher priority than data transmission from the STA to the AP.
